(19) United States
(12) Patent Application Publication
(10) Pub. No.: US 2007/0045157 A1
(43) Pub. Date: Mar. 1, 2007

(54) Recovery of pin chips from a chip washing reject stream

(76) Inventors: Wieslaw C. Kajzer, Gainesville, GA (US); Jeffrey W. Bowie, Suwanee, GA (US)

Correspondence Address: STIENNON & STIENNON, 612 W. MAIN ST., SUITE 201, P.O. BOX 1667, MADISON, WI, 53701-1667, US

(21) Appl. No.: 11/214,278

(22) Filed: Aug. 29, 2005

(51) Int. Cl. B03B 1/00; D21C 9/02

(52) U.S. Cl. 209/3; 162/60; 162/55; 209/17; 209/158; 134/133; 210/97

(57) ABSTRACT

A recovery process and apparatus employing a pressure water washer to process wood chip wash water, to separate pin chips from sand and dirt contained in the wash water. Wash water from a chip wash system is supplied to a pressure washer having a cylindrical screening basket and a rotor positioned within the basket. The screen basket has holes of 1-3 mm which allows dirt and sand to pass but retains pin chips. The wood fiber pin chips on the way to the accepts outlet thus do not pass through the screen basket. Additional water may be added to the pressure washer to balance the flow of water along and through the screen basket.

### BACKGROUND OF THE INVENTION

The present invention relates to systems for washing chips and to systems for recovering wood fibers from wastewater streams.

Mechanical, chemical, and semi-chemical wood pulps are created from wood chips which allows mechanical, or chemical action to uniformly act on the fibers contained in the raw wood starting material. The wood chips often become contaminated with sand, dirt, rocks, scrap metal, and broken glass. The contamination can arise because waste materials are used to generate the wood chips or because of storage of wood chips on the ground, or due to wind and water depositing sand and dust on the chips during storage or handling. Such contamination of the wood chips is undesirable because it affects the quality of the finished product made from the wood fibers and because it causes excessive wear and tear on equipment handling the chips and the fibers produced therefrom. Therefore wood chips are often washed, typically with water, before they are further processed, and the wash water is purified and the contaminants are discarded. The washing process often takes place in an unpressurized chip washer which uses a screen with holes through which dirt and contaminants are washed. Because of the requirements of chip washing, the screen holes in the chip washer are often of sufficient size that chip pins, i.e. small slivers of wood of about a sixteenth of an inch in diameter or less and about a quarter-inch long, are lost with the wash water.

Although only a small percentage of the wood fiber contained in the wood chips is lost with the wash water, over the course of a day in a large modern pulp or fiber making facility, 10 to 15 tons of dry weight fiber per day can be lost with the wash water from the chip washing system. This can represents a cost of $500 to $1,000 a day depending on fiber recovery and value. What is need is a method of recovering clean pin chips from wood chip wash water.

### SUMMARY OF THE INVENTION

The recovery process and apparatus of this invention employs a chip wash system to clean wood chips, and a pressure washer to process the wash water, to separate pin chips from the sand and dirt contained in the wash water. Used water from a chip wash system such as used in the pulp and paper and fiberboard industry, is supplied to a pressure washer having a cylindrical screening basket and a rotor positioned within the screen basket which moves hydrofoil shaped blades or foils over the surface of the screen basket.

The recovery water is supplied at a pressure of, for example, of about 1-40 psi and the rotor causes positive and negative pressure pulses. The positive pressure pulses aid the passage of the rejected sand and dirt through the screen basket, and the negative pressure pulses periodically back flush holes formed in the screen basket, thus keeping the holes from becoming plugged. A screen basket with holes of 1-3 mm rather than slots is used because the dirt and sand easily pass through the screen basket holes but the pin chips do not. The wood fiber in the form of pin chips, i.e., the accept, do not pass through the screen basket, but the rejects consisting of sand and dirt or mud do. Contrary to normal practice, the accepts, i.e. the pin chips, do not pass through the screen basket. Therefore additional water may be added to the pressure washer to balance the through screen water velocity, with a flow volume and velocity along the screen basket so as to move the pin chips along the screen basket surface and out of the pressure washer.

It is a feature of the present invention to reduce the cost of washing wood chips by recovery of wood fiber.

It is a further feature of the present invention to recover wood fiber from the wash water of a chip washing system.

It is another feature the present invention to configure a pressure washer following a chip washing system to recover pin chips, and to reject sand and dirt.

Further objects, features and advantages of the invention will be apparent from the following detailed description when taken in conjunction with the accompanying drawings.

### BRIEF DESCRIPTION OF THE DRAWINGS

FIG. 1 is a schematic view of a chip washer system, in combination with a pressure washer of this invention.

FIG. 2 is a side elevational schematic cross-sectional view of the pressure washer of FIG. 1.

FIG. 3 is a side elevational schematic cross-sectional view of an alternative embodiment of the pressure washer of this invention.

### DESCRIPTION OF THE PREFERRED EMBODIMENTS

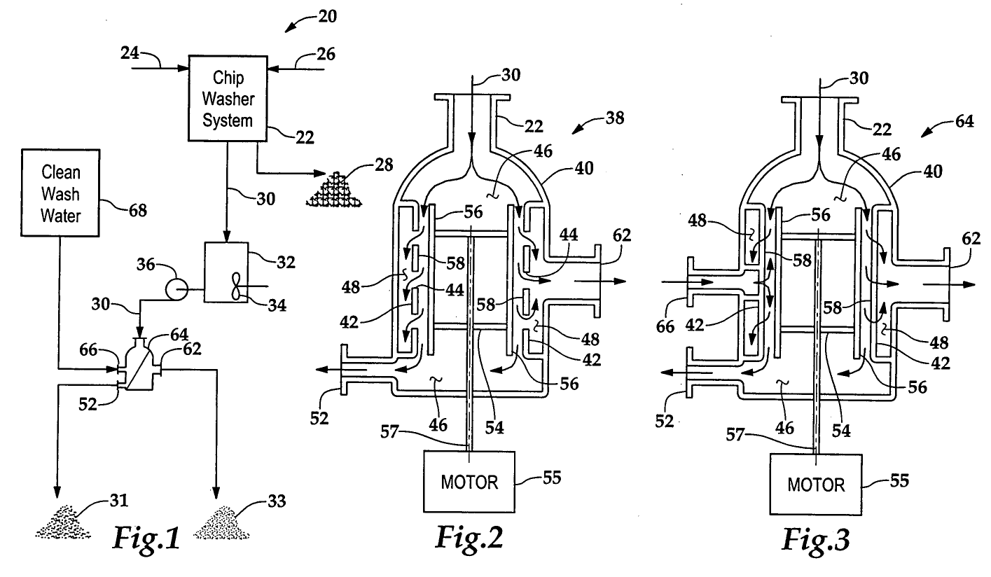

Referring more particularly to FIGS. 1-3, wherein like numbers refer to similar parts, a wood chip wash system 22 is shown in FIG. 1. The wood chip wash system 22 forms a part of a chip wash and recovery system 20, and is supplied with wood chips 24, and water 26, and outputs clean wood chips 28 and wash water 30 containing pin chips 31, mud, and sand 33. The wash water 30 then flows into a slurry tank 32 which is equipped with an agitator 34, and a pressure washer feed pump 36. The retention time within the slurry tank is about one to ten minutes following which the wash water 30 is fed under pressure produced by the pump 36 into a pressure washer 38 as shown in FIG. 2 or the pressure washer 64 as shown in FIGS. 1 and 3. The general attributes of the pressure washers 38, 64 such as the use of holes instead of slots in the screen basket, the addition of supplemental feedwater, and the general arrangement of a rotor for causing pressure pulses to prevent clogging of the screen are well-known. However, the particular application and arrangement of components perform a new function of recovering fiber which would otherwise be discarded. Further, the pressure washers 38, 64 are particularly configured so as to perform the new function of separating pin chips from the sand and dirt in the wash water 30.

The pressure washer 38 has a pressure vessel 40, and a screen basket 42 which is arranged to form a cylinder which has screening holes 44, as shown in FIG. 2. The screen holes 44 are shown exaggerated in FIG. 2 for illustrative purposes and have an actual diameter of approximately 1 to 3 mm, and substantially fill the surface 58 on the screen basket cylinder. The screen basket 42 defines a pre-filter interior volume 46 and a post filter volume 48. The pre-filter interior volume 46 is supplied with wash water 30 through an inlet pipe 50 and is connected to an accept outlet 52 through which pin chips 31 are recovered. A rotor 54 is positioned to rotate about an axis 57 defined by the cylindrical screen basket 42, and driven by a motor 55. The rotor 54 may take the form of any conventional rotor which moves rotor foils 56 in a circular motion closely spaced from the inside surface 58 of the screen basket 42, for example 1 to 6 mm.

The foils 56 produce a positive pressure pulse followed by a negative pressure pulse sufficient to keep the holes in the cylindrical screen basket 42 from clogging. A negative pressure pulse of sufficient magnitude causes a back flushing of the screen basket 42 so as to periodically clear the holes of the screen basket. A pressure screen such as that manufactured by Metso Paper, Inc. in 2003, such as FS-560LC/HC under the trademark Optiscreen SF type, or pressure screens manufactured by other suppliers such as Hooper may be modified to form the pressure washers 38, 64. These screens, while not having the specific screen arrangement of the invention, provide an example of the basic design which can be configured and used in accord with the invention.

Normally the accept output of a pressure washer passes through the screen basket, however in the pressure washer filter 38 it is the rejected sand and dirt which passes through the screen basket 42, and the accept flow of pin chips which are retained by the cylindrical screen basket 42 move along between the screen and the rotor 54 always remaining in the prefilter interior volume and exiting through the accept outlet 52. On the other hand, the reject flow passes through the screen's 1 to 3 mm holes 44 and is passed through the post filter interior volume 48 to the reject flow outlet 62.

The majority of the flow from the pressure washer 38 passes through the screen basket 38 to the reject outlet 62. The flow within the pressure washer 38 is controlled so that the water velocity through the holes 44 of the screen basket 42 are such as to lead to effective passage of dirt and sand 33 contained in the wash water 30 through the screen basket 42, at the same time so as to allow sufficient flow to move the retained pin chips along the screen basket surface 58 to the accept outlet 52. As shown in FIG. 3, an alternative embodiment pressure washer 64 is shown which in addition to the parts described with respect to FIG. 2 includes a supplemental water inlet 66 which allows a flow of clean wash water 68 to pass to the prefilter interior volume 46 and increases the water flow available to move the pin chips to the outlet 52.

Typical water and material flows for a representative chip wash and recovery system 20 are for example 625 bone dry metric tons per day (BDMT/D) and over 14,000 tons of water. The output of the chip wash and recovery system 20 is 5,000 to 10,000 liters per minute of water and 10 to 20 BDMT/D of pin chips and contaminants, which flow into a tank 32 with a volume of 5-100 cubic meters. Thus the average time that the flow is acted upon in the tank by the agitator 34 is about 1 to 10 minutes. From the slurry tank 32 the pump 36 passes the wash water 30 under a pressure of about 1 to 40 psi to the pressure washer 38, 64 where the pressure drop across the screen of the screen basket is typically about 5 psi. The pressure washer reject flow to the outlet 62 is about 4,500 to 9,000 liters per minute containing about 2.5 to 5 BDMT/D of sand and mud 33. And the pressure washer 38, 64 flow to the accept outlet 52 is about 500 to 1,000 liters per minute and 7.5 to 15 BDMT/D of pin chips. In addition, a certain amount of clean wash water 68 may be supplied to the supplemental water inlet 66 to increase the water flow with the pin chips, if necessary, for proper functioning of the pressure washer 64.

It should be understood that the chip wash and recovery system 20 will not recover all fiber in the wood chip wash water, but can be expected to recover the majority of such fiber, particularly the fiber contained in pin chips of approximately 1/16 inch in diameter and in the neighborhood of a quarter inch long. It should also be understood that the holes formed in the screen basket will have a diameter approximately that of the diameter of the pin chips, however for optimal sizing it may be necessary to try screen holes of varying sizes to obtain the best recovery from a particular wash water stream.

It should be understood that the holes 44 are preferably circular but may deviate from circular so long as the holes easily pass the sand and dirt but retain the pin chips. It should also be understood that the screen basket is preferably cylindrical but could be constructed with any shape forming a surface of revolution whose axis is the axis 57 about which the rotor 54 turns. The pressure developed across the screen of the screen basket is a pressure effective to obtain selected flow rates through the screen basket 42 and which at the same time can be overcome by the negative pressure caused by the rotor 54 and the foils 56 attached thereto, and for example may be about 5 psi.

It should be understood that the pressure washer may be fed by pressurizing the wash water with a pump or by using gravity to establish the necessary pressure head to thus connect the pressure washer in pressure increasing relation to the wash water outlet of the chip washer system.

It is understood that the invention is not limited to the particular construction and arrangement of parts herein illustrated and described, but embraces all such modified forms thereof as come within the scope of the following claims.

We claim:

1. A method of cleaning wood chips and recovering the fiber from a wash water stream, comprising the steps of:
washing wood chips with water to produce wash water as a result of the step of washing;
separating clean chips from the wash water;
feeding the wash water at a selected pressure into a pressure washer, having a screen basket;
separating sand and dirt from pin chips which are contained in the wash water by passing the wash water over the screen basket which is defined by a surface of revolution and defines a multiplicity of holes of from 1 to 3 mm in diameter which holes pass through the screen basket;
using a rotor turning inside the screen basket, and closely spaced from the screen basket to create periodic negative pressure pulses which clean the multiplicity of holes;
by means of the selected pressure, passing water and sand and dirt through the screen basket to form a reject flow which exits the pressure washer; and
recovering a stream of water and pin chips which have not passed through the screen basket through an accept outlet of the pressure washer.

2. The method of claim 1 wherein the screen basket which is defined by a surface of revolution is defined by a cylindrical surface.

3. The method of claim 1 further comprising the step of supplying clean wash water to the pressure washer at a point between the axis of the screen basket and a surface defined by the screen basket.

4. The method of claim 1 further comprising the step of agitating the wash water in the tank sized to a wash water residence time of about one to ten minutes, and pressurizing the wash water with a pump prior to feeding the wash water to the pressure washer.

5. The method of claim 1 wherein a pressure drop across the screen basket of about 5 psi is formed.

6. An apparatus comprising:
a chip wash system having a water supply inlet and a chip supply inlet, and having a chip outlet and a wash water outlet;
a pressure washer having an inlet and connected at the inlet in pressure increasing relation to the wash water outlet;
wherein the pressure washer has a screen basket defining a surface of revolution about an axis, and wherein said screen basket defines a multiplicity of holes of a diameter of approximately 1 to 3 mm which pass through the surface of revolution, and a rotor mounted for rotation about the axis and closely spaced from the surface;
an accept outlet connected in fluid receiving relation to a volume defined between the screen basket and the axis, so that a fluid flow passes from the inlet to the accept outlet without passing through the holes in the screen basket; and
a reject outlet connected in fluid receiving relation to a volume defined within the pressure washer which can only be reached by passing through the holes in the screen basket.

7. The apparatus of claim 6 further comprising a clean wash water inlet which is connected to the volume defined between the screen basket and the axis.

8. The apparatus of claim 6 further comprising:
a slurry tank in wash water receiving relation to the wash water outlet:
an agitator mounted within the slurry tank; and
a pump in wash water receiving relation to the slurry tank, the pump connected in pressure increasing relation to the pressure washer inlet.

9. The apparatus of claim 6 wherein the surface of revolution about the axis defines a cylinder.

10. A method of recovery of pin chips from water created by washing wood chips, the method comprising the steps of:
pressurizing the wash water to a selected pressure which at a screen basket of a pressure washer is less in magnitude than a selected negative pressure;
and
separating wood chip pins from sand and dirt in the wash water by passing the wash water over the screen basket within the pressure washer, while the screen basket is periodically cleaned by the action of a rotor causing a pressure pulse of the selected negative pressure on the screen basket, so that a portion of the wash water containing sand and dirt passes through the screen basket, and a portion of the wash water containing the chip pins does not pass through the screen basket, but instead passes to an accept outlet of the pressure washer.

11. The method of claim 10 wherein the dirt and sand are passed through 1 to 3 mm in diameter holes defined by the screen basket.

12. The method of claim 10 further comprising the step of adding clean wash water to the wash water within the the pressure washer so that the clean wash water is added to a stream of wash water which has not passed through the screen basket.

13. The method of claim 10 further comprising the step of agitating the wash water for a period of approximately 1 to 10 minutes before pressurizing the wash water.

14. The method of claim 10 wherein the selected pressure is about 5 psi.
